(19) United States
(12) Patent Application Publication
(10) Pub. No.: US 2003/0112271 A1
(43) Pub. Date: Jun. 19, 2003

(54) Method of controlling a browser session

(75) Inventors: Glenn Darrell Batalden, Rochester, MN (US); Keith Evans Bright, Cedar Park, TX (US); Mark Earl Plunkett, Oronoco, MN (US)

Correspondence Address: Gero G. McClellan, Moser, Patterson & Sheridan, L.L.P., Suite 1500, 3040 Post Oak Boulevard, Houston, TX, 77056-6582, US

(73) Assignee: International Busi ness Machines Corporation, Armonk, NY

(21) Appl. No.: 10/020,026

(22) Filed: Dec. 14, 2001

(51) Int. Cl. G09G 5/00

(52) U.S. Cl. 345/744; 345/854

(57) ABSTRACT

Method, article of manufacture and apparatus for controlling the operation and appearance of browsers. A controlled browser window comprises a display area for rendering viewable content received from received from network locations. A controlling browser window is configured to control aspects of the controlled browser window. In one embodiment, a program implementing the controlling browser window comprises event handlers which produce a predetermined result in response to events occurring with respect to the controlled browser window. The event handlers may be re-established for each domain change of the controlled browser window.

### BACKGROUND OF THE INVENTION

1. Field of the Invention

The present invention generally relates to data-processing. More particularly, the invention relates to browsers.

2. Description of the Related Art

Computer networks were developed to allow multiple computers to communicate with each other. In general, a network can include a combination of hardware and software that cooperates to facilitate the desired communications. One example of a computer network is the Internet, a sophisticated worldwide network of computer system resources.

Networks, such as the Internet, require a network browser to enable navigation between network addresses. A browser is an application program or facility that normally resides on a user's workstation and which is invoked when the user decides to access network addresses. A prior art Internet browser program typically accesses a given network address according to an addressing format known as a uniform resource locator (URL). The browser also processes each type of data which is presented to it, and forwards and receives data to and from the network. State-of-the-art browsers provide a complete multimedia experience, including video, pictures, 3-D images, sounds and the like. In addition, browsers provide useful features that facilitate management of the voluminous information encountered by users while browsing. For example, most commercially available Internet browsers (e.g., Netscape's Navigator® and Windows' Explorer®) provide a history folder containing recently visited network addresses (e.g., web sites) and a bookmark folder to which a user can store network addresses for future retrieval.

Conventional browsers typically include menu bars, toolbars and other features facilitating operation. Such features can be seen in FIG. 1, which shows a graphical user interface 100 for a Netscape Navigator browser. For simplicity, some of the features and content have not been shown. In general, the interface 100 includes a title bar 102, a menu bar 104, a navigation tool bar 106, and address field 108, a personal tool bar 110 and a viewing area 112. One or more of the foregoing features may be customizable by users. For example, users may generally add or remove various buttons from the navigation tool bar 106.

In addition to providing for user configuration of the browser's graphical user interface, users may also configured the operation of the browser. For example, a user may elect to disable our enable the browser's ability to render Java content. Accordingly, browsers provide users with a high degree of flexibility in terms of the “look and feel” of the interface as well as the operation of the browser.

While the flexibility provided by today's browsers is generally desirable to end-users, other parties may desire to limit the end-users' control over the browser. For example, employers may desire to limit employees control over browsers installed on office computers. As another example, web sites sponsors may desire their web sites to be viewed in a particular manner and to restrict a user's ability to operate their browser while viewing the website.

Therefore, there is a need for a system, article of manufacture and method to control the operation of browsers.

### SUMMARY OF THE INVENTION

The present invention generally provides a method, article of manufacture and apparatus for controlling the operation and appearance of browsers.

One embodiment provides a method for controlling a first browser window using a second browser window. The method comprises opening a controlling browser window configured to control aspects of a controlled browser window and opening the controlled browser window which comprises a display area for rendering viewable content received from received from network locations. In one embodiment, the controlled browser window is opened from the controlling browser window. In another embodiment, the controlled browser window is opened before the controlling browser window.

Another embodiment provides a computer readable medium containing a controlling browser program which, when executed, performs the foregoing method.

Still another embodiment provides a computer, comprising a processor and a memory containing at least browser programming. When executing the browser programming, the processor is configured to: open a controlling browser window configured to control aspects of a controlled browser window and open the controlled browser window comprising a display area for rendering viewable content received from network locations. In one embodiment, the aspects to be controlled comprise at least one of operational aspects and graphical aspects of a graphical user interface.

### BRIEF DESCRIPTION OF THE DRAWINGS

So that the manner in which the above recited features, advantages and objects of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 is a prior art graphical user interface of a browser.

FIG. 2 is a high-level block diagram of a networked system.

FIG. 3 is a graphical user interface of a browser having selected features modified.

FIG. 4 is a graphical user interface of a browser having selected features modified and configured with a custom button bar.

FIG. 5 is a graphical user interface of a browser having selected features modified and configured with a custom button bar.

FIG. 6 is a flowchart illustrating the implementation of a controlling browser window and a controlled browser window.

FIG. 7 is a flowchart illustrating the operation of event handlers in response to an unload event.

FIG. 8 is a flowchart illustrating the operation of event handlers.

### DETAILED DESCRIPTION OF THE PREFERRED EMBODIMENTS

The present invention generally provides a method, article of manufacture and apparatus for controlling the operation and appearance of browsers. In one embodiment, a controlled browser window and a controlling browser window are implemented. The controlled browser window comprises a display area for rendering viewable content received from network locations. The controlling browser window is configured to control aspects of the controlled browser window. In one embodiment, a program implementing the controlling browser window comprises event handlers which produce predetermined results in response to events occurring with respect to the controlled browser window. The event handlers may be re-established for each domain change of the controlled browser window.

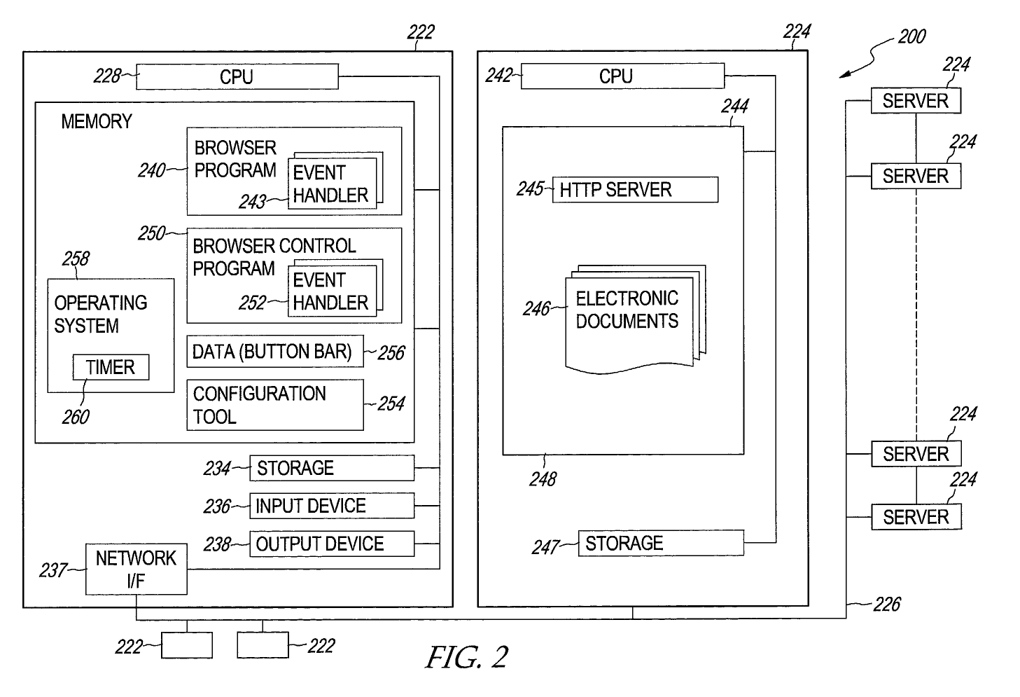

As will be described below, aspects of the preferred embodiment pertain to specific method steps implementable on computer systems. Further, one embodiment of the invention is implemented as a program product for use with a computer system such as, for example, the network environment 200 shown in FIG. 2 and described below. The program(s) of the program product defines functions of the embodiments and can be contained on a variety of signal-bearing media. Illustrative signal-bearing media include, but are not limited to: (i) information permanently stored on non-writable storage media (e.g., read-only memory devices within a computer such as CD-ROM disks readable by a CD-ROM drive); (ii) alterable information stored on writable storage media (e.g., floppy disks within a diskette drive or hard-disk drive); or (iii) information conveyed to a computer by a communications medium, such as through a computer or telephone network, including wireless communications. The latter embodiment specifically includes information downloaded from the Internet and other networks. Such signal-bearing media, when carrying computer-readable instructions that direct the functions of the present invention, represent embodiments of the present invention.

In general, the routines executed to implement the embodiments of the invention, may be part of an operating system or a specific application, component, program, module, object, or sequence of instructions. The computer program(s) of the present invention typically is comprised of a multitude of instructions that will be translated by the native computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

In some cases, embodiments of the invention may be implemented using specific programming languages and applications. For example, in one embodiment JavaScript is used to advantage with a Netscape® browser. However, it is understood that any reference to a particular embodiment is merely illustrative. Accordingly, embodiments may also be implemented using other browsers, such as Microsoft's Internet Explorer, and other programming languages such as scripts including Visual Basic, Perl and REX and even non-script languages including procedural languages (such as C) and object-oriented languages (such as Java and C++).

FIG. 2 depicts a networked system 200 in which embodiments of the invention may be implemented. In general, the networked system 200 includes a client (e.g., user's) computer 222 (three such client computers are shown) and at least one server 224 (five such servers 224 are shown). The client computer 222 and the server computer 224 may be the components of the same computer system, or may be connected via a network 226. In general, the network 226 may be a local area network (LAN) and/or a wide area network (WAN). In a particular embodiment, the network 226 is the Internet.

The client computer 222 includes a Central Processing Unit (CPU) 228 connected via a bus 230 to a memory 232, storage 234, input device 236, output device 238 and a network interface device 237. The input device 236 can be any device to give input to the client computer 222. For example, a keyboard, keypad, light-pen, touch-screen, track-ball, or speech recognition unit, audio/video player, and the like could be used. The output device 238 is preferably any conventional display screen and, although shown separately from the input device 236, the output device 238 and input device 236 could be combined. For example, a display screen with an integrated touch-screen, and a display with an integrated keyboard, or a speech recognition unit combined with a text speech converter could be used.

The network interface device 237 may be any entry/exit device configured to allow network communications between the client computer 222 and the server computers 224 via the network 226. For example, the network interface device 237 may be a network adapter or other network interface card (NIC).

Memory 232 is preferably random access memory sufficiently large to hold the necessary programming and data structures of the invention. While memory 232 is shown as a single entity, it should be understood that memory 232 may in fact comprise a plurality of modules, and that memory 232 may exist at multiple levels, from high speed registers and caches to lower speed but larger DRAM chips.

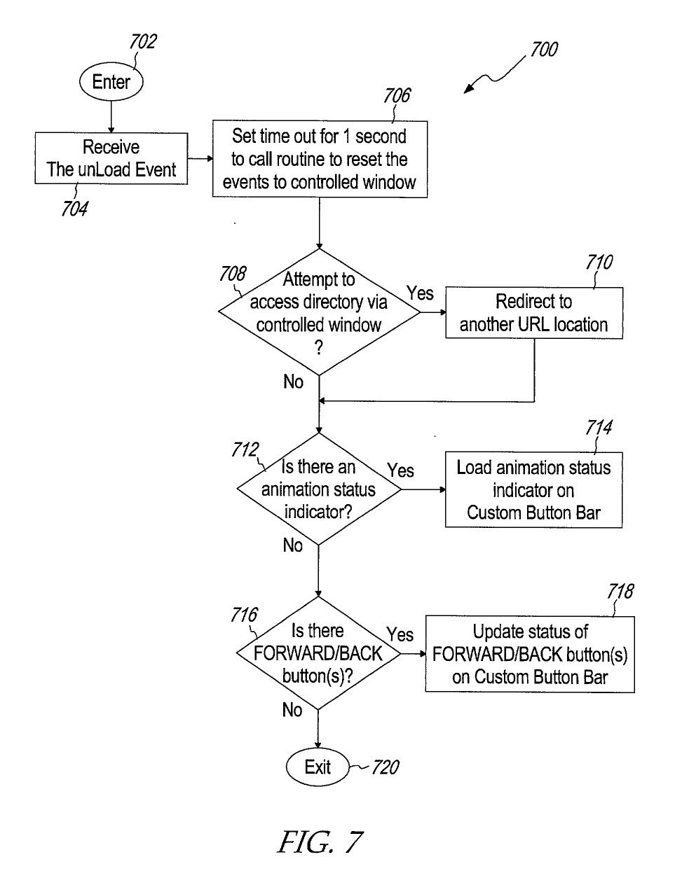

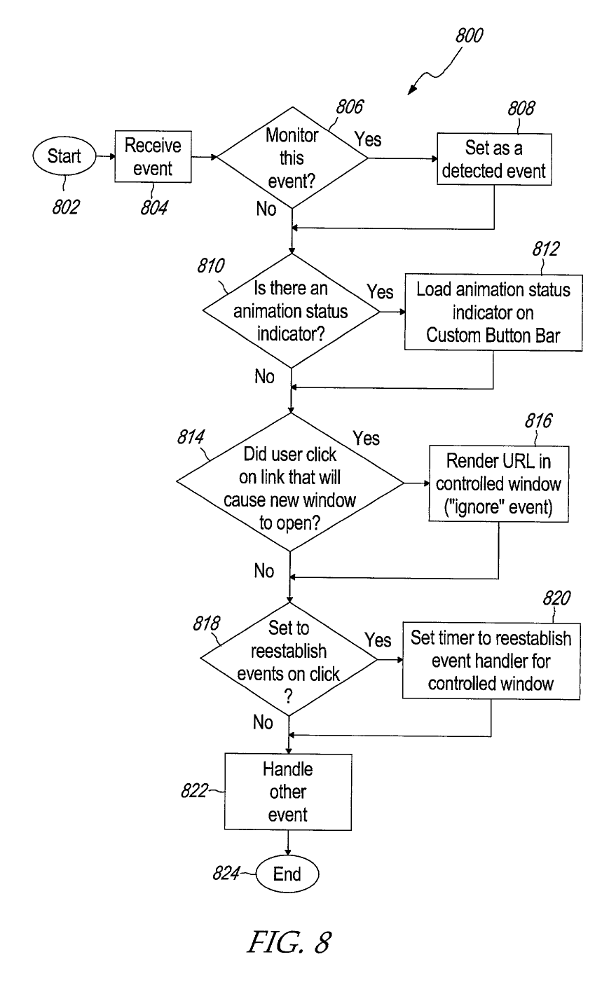

Memory 232 contains a browser program 240 that, when executed on CPU 228, provides support for navigating between the various servers 224 and locating network addresses at one or more of the servers 224. In one embodiment, the browser program 240 includes a web-based Graphical User Interface (GUI), which allows the user to display web pages located on the Internet. The browser program 240 is shown configured with a plurality of event handlers 243. Each of the event handlers 243 is configured for a different event. Illustrative events include abort, error, load, mouse activity, keyboard activity, submit, reset, etc. In a particular embodiment, the event handlers 243 are implemented as JavaScript. However, as noted above, the invention is not limited to a particular programming language and persons skilled in the art will recognize that other languages may be used to advantage. The operation of the event handlers 243 will be described in more detail below with respect to FIGS. 7 and 8.

Memory 232 also contains a browser control program 250. When executed on CPU 228, the control program 250 operates to control aspects of a browsing session. In one embodiment, the control program 250 opens a controlling window which exerts a degree of control over a controlled window opened by the browser program 240. To this end, the controlling window may be opened first and then cause the controlled window to be opened. Alternatively, the controlled window may already be open when the controlling window is subsequently opened. In general, the controlling window may be hidden or visible. Illustratively, the control window may restrict a user's ability to configure the graphical user interface of the browser program 240, change the appearance of the graphical user interface, prevent access to one or more network addresses, lock one or more keyboard buttons, lock one or more mouse buttons, etc. In one embodiment, control over the controlled window opened by the browser program 240 is implemented by the event handlers 243 which, in turn, are implemented by the browser control program 250. Further, the browser control program 250 is itself configured with event handlers 252. Each of the event handlers 252 is configured for a different event. In one embodiment, one of the event handlers 252 is configured to close the controlled window in response to the controlling window being closed. This may be desirable to prevent a user from hacking into the code of the browser program 240. Further, the event handlers 252 are responsible for managing a custom button bar (which is one instance of the controlling window and will be described further below). In a particular embodiment, the event handlers 252 are implemented as JavaScript. However, as noted above, the invention is not limited to a particular programming language and persons skilled in the art will recognize that other languages may be used to advantage.

The browser control program 250 may be configured by a configuration tool 254. For example, in one embodiment the configuration tool 254 allows an administrator (or other user with access to configuration tool 254) to select which portions of a browser interface (i.e., the visible controlled window) will be visible and/or available to a user. The configuration tool 254 can be separate from, or integral to, the browser program 240.

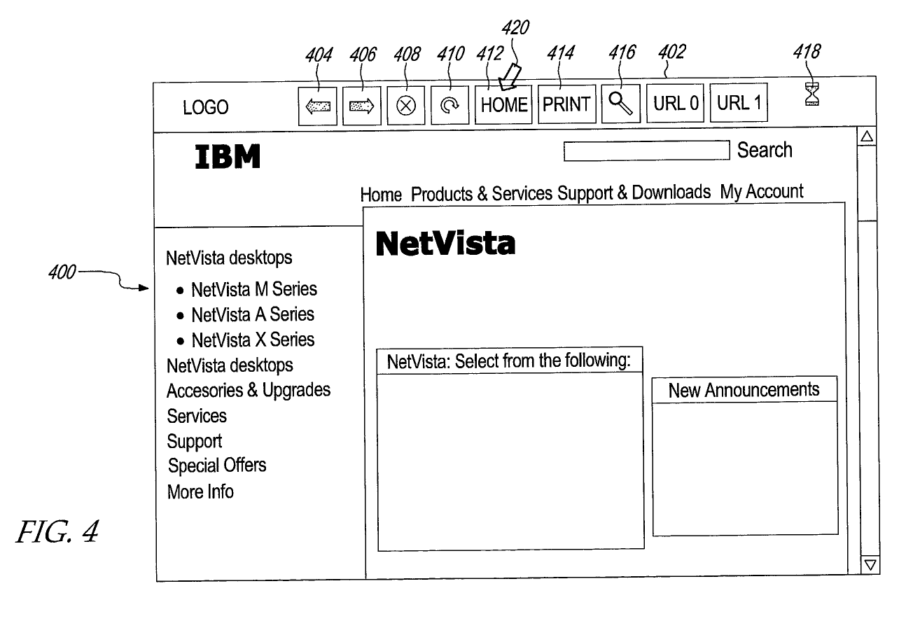

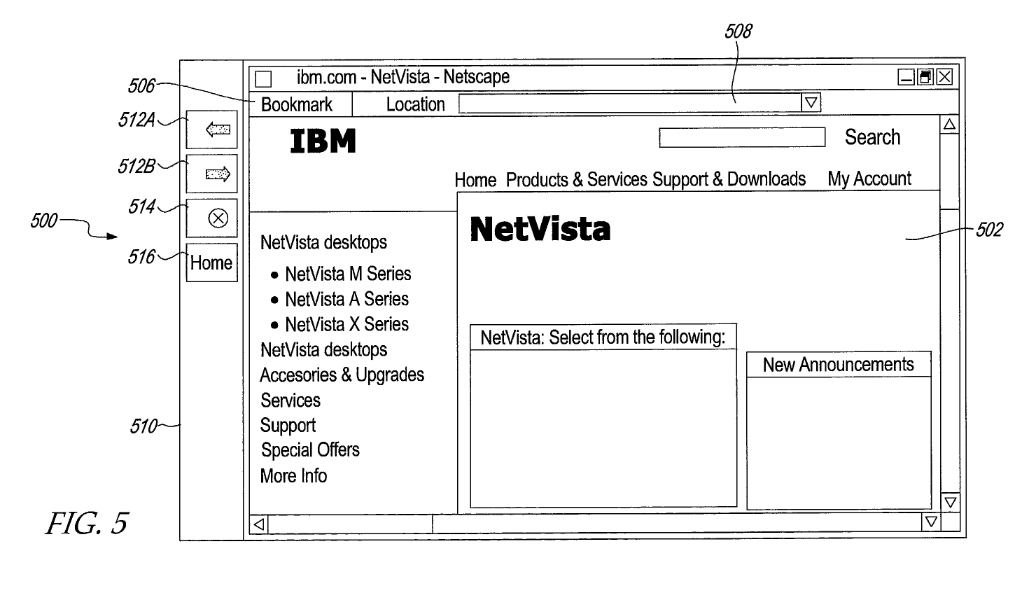

Memory 232 also comprises various data structures 256 used by, for example, the browser control program 250. For example, the data structure 256 may include elements of the controlling window implemented by the browser control program 250. Such elements may include features of a custom button bar, such as the one described below with reference to FIG. 4 and FIG. 5.

The client computer 222 is generally under the control of an operating system 258, which is also located in memory 232. Illustrative operating systems which may be used to advantage include IBM's AIX operating system, Linux and Windows. More generally, any operating system supporting browser functions may be used. In one embodiment, the operating system 258 includes a timer 260. The timer 260 may be, for example, any one second timer suitable for monitoring the controlled window opened by the browser program 240 and for re-establishing the event handlers 252.

Storage 234 is preferably a Direct Access Storage Device (DASD), although it is shown as a single unit, it could be a combination of fixed and/or removable storage devices, such as fixed disc drives, floppy disc drives, tape drives, removable memory cards, or optical storage. Memory 232 and storage 234 could be part of one virtual address space spanning multiple primary and secondary storage devices.

Each server computer 224 generally comprises a CPU 242, a memory 244, and a storage device 247, coupled to one another by a bus 248. Memory 244 is a random access memory sufficiently large to hold the necessary programming and data structures that are located on the server computer 224. As shown, the memory 244 includes a Hypertext Transfer Protocol (http) server process 245 adapted to service requests from the client computer 222. For example, process 245 may respond to requests to access electronic documents 246 (e.g., HTML documents) residing on the server 224. The http server process 245 is merely illustrative and other embodiments adapted to support any known and unknown protocols are contemplated. The programming and data structures may be accessed and executed by the CPU 242 as needed during operation.

FIG. 2 is merely one hardware/software configuration for the networked system 200, client 222 and server 224. Embodiments of the present invention can apply to any comparable hardware configuration, regardless of whether the computer system is a complicated, multi-user computing apparatus, a single-user workstation, or network appliance that does not have non-volatile storage of its own.

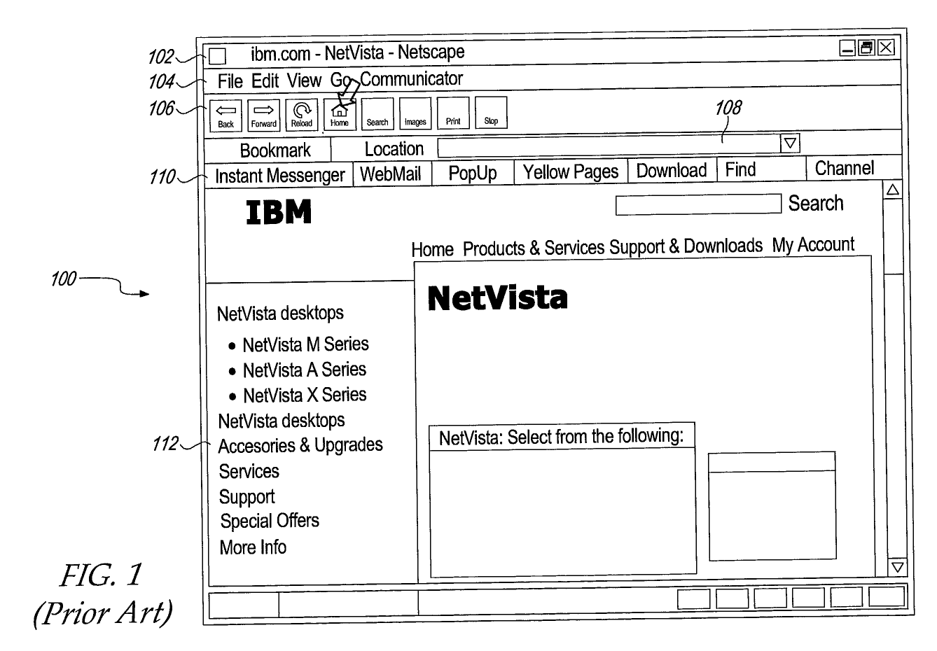

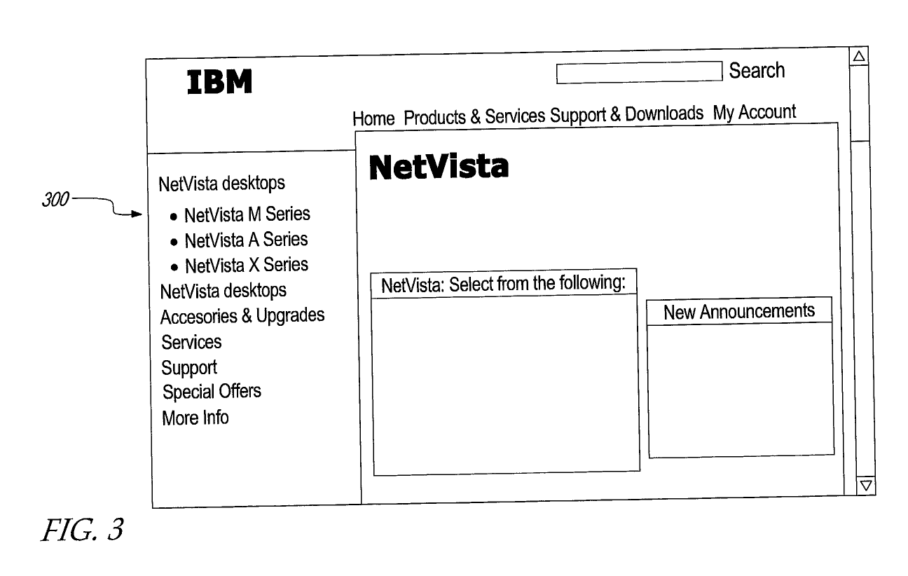

As noted above, the browser control program 250 restricts, modifies or otherwise controls the operation or the appearance of the browser program 240. For purposes of comparison, an illustrative graphical user interface 100 implemented by the browser program 240, without modification by the browser control program 250, is shown in FIG. 1 and has been described above. In contrast, FIG. 3 shows a browser interface 300 under the control of the browser control program 250 in which aspects of the browser chrome has been removed. The browser chrome which has been removed includes, for example, the title bar 102, the menu bar 104, the navigation bar 106, the network address field 108, the personal tool bar 110 and the border which defines the viewing area 112.

In addition to removing aspects of the browser chrome, the browser control program 250 may also be configured to add aspects to a browser interface. For example, the interface 400 shown in FIG. 4 includes a custom button bar 402. The custom button bar 402 is a visible representation of the controlling window implemented by the browser control program 250, while the remainder of the visible interface 400 is the controlled window implemented by the browser program 240. Illustratively, the custom button bar 402 includes navigation buttons such as a “back” button 404 and a “forward” button 406 to move between one or more previously visited network addresses, a “stop” button 408 to stop a request, a “reload” button 410, a “home” button 412 to access the homepage network address, a “print” button 414, and a “search” button 416. Further, the custom button bar 402 is configured with an animated feature 418. In the particular embodiment shown, the animated feature 416 is an hourglass which rotates.

Another embodiment of a controlled window and a controlling window is illustrated by the interface 500 shown in FIG. 5. In this case, the controlled window generally includes a display area 502 for rendering Web content, a title bar 504 and a button bar 506 which includes an address field 508. The visible portion of the controlling window is again represented as a custom button bar 510. In this embodiment, the custom button bar 510 includes navigation buttons 512A-B, a “stop” button 514 and a “home” button 516. In contrast to the button bar 402 shown in FIG. 4, the button bar 510 is located lengthwise along a left-hand side of the controlled window.

As described above, the data used to implement the various buttons of the custom button bar 402 is contained in the data structure 256. Further, animated portions of the controlling window, such as the animated feature 416 shown in FIG. 4, may be implemented as Graphics Interchange Format (GIF) files. In one embodiment, the buttons of the custom button bar 402 are implemented in a manner that is supported by any operating system currently available. To this end, the buttons are illustratively implemented using Hypertext Markup Language (HTML). HTML tags known as MAP tags and AREA tags define each button. Each button may have three associated images, referred to as tri-state buttons. The tri-state buttons include “MouseUp”, “MouseDown” and “MouseOver”. A representation of each of the three states is seen in FIG. 4. For example, the “back” and “forward” buttons 404, 406 illustrate a “MouseDown” button state. The “stop” button 408 illustrates a “MouseUp” button state. Finally, the “home” button 408 illustrates a “MouseOver” button state. The particular state of a custom bar button is dependent upon the position of the pointer 420 and whether the user is clicking on the custom bar button. For example, the “home” button 408 is in a “MouseOver” button state as a result of the pointer 420 being positioned over the button 408. Once the pointer 420 is moved outside of the area defining the button, the button changes state. For example, the button may resume a “MouseUp” state. Further, inactive/unavailable buttons may be greyed out and in a “MouseDown” image state, as in the case of the navigation buttons 404, 406.

Illustratively, the event handler values for the AREA tag are: click (which returns false), MouseOut (which updates a button), and MouseOver (which updates a button). Illustrative code defining an AREA is shown below in Table I. Note that HREF (which is used to call a URL) is set to NULL to ensure that that a click event (defined as the serial combination of an up and down mouse button sequence, which would thereby invoke a “click event” handler for the defined AREA) will return false, in order to avoid calling a URL.

TABLE I
<MAP NAME=“map”><AREA NAME=“sample” COORDS=“0,0,100,100” HREF=“”
onMouseOut=“doit_out();return true” onClick=return false”
on MouseOver=“doit_over(); return true”
ID= “area_sample” ></MAP>

Each AREA tag as a corresponding HTML IMG tag. The IMG tag is linked to the AREA via the MAP tag. The event handlers for the IMG tag are MouseUp (which updates the image) and MouseDown (which updates the image and processes the action). Illustrative code for images corresponding to the code of Table I is shown below in Table II.

TABLE II
<IMG SRC=“sample.gif” BORDER=“0” ALIGN=“top”
HEIGHT=“100” WIDTH=“100”
VSPACE=“2” USEMAP=“#map” onMouseUp=“doit_up();return true”
onMouseDown=“doit_down() return true” ID=“img_sample”>

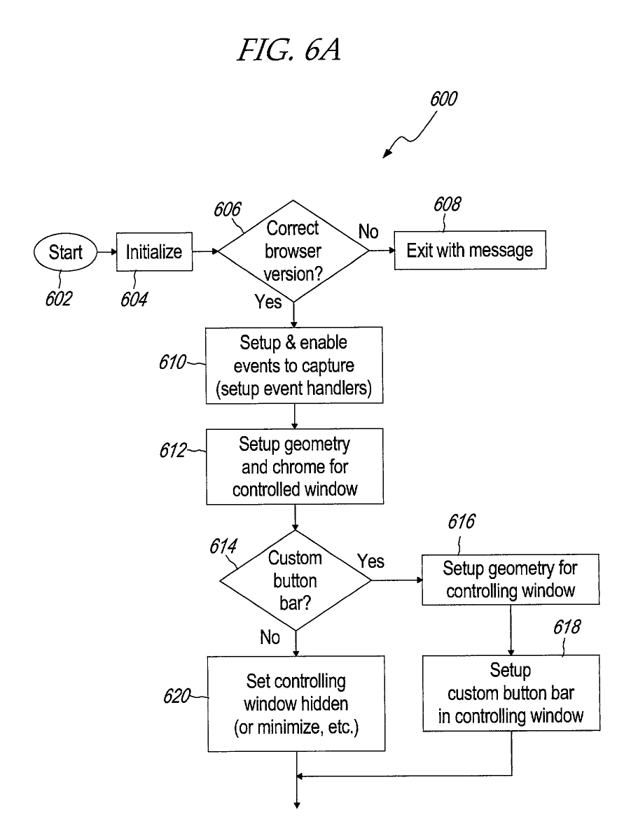

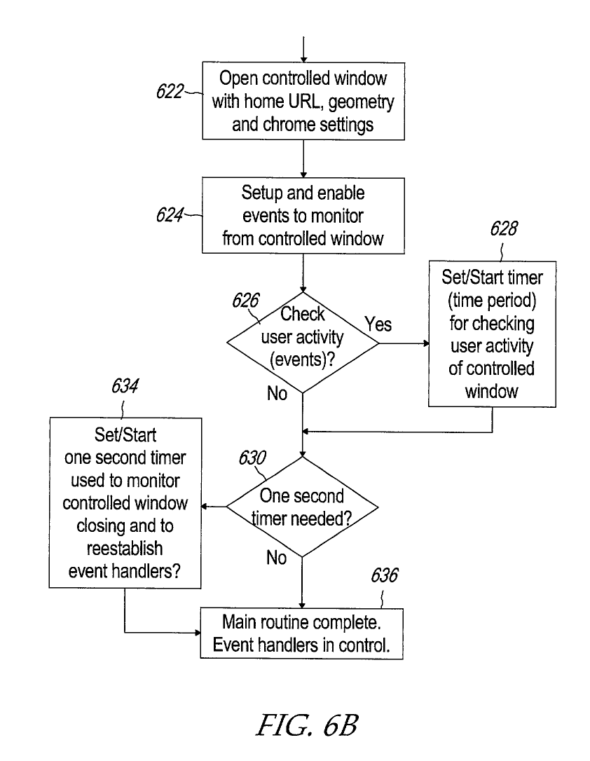

FIGS. 6-8 illustrate methods of operation for the browser program 240 and the browser control program 250. For purposes of illustration, it will be assumed that the browser program 240 is Netscape Navigator. However, as previously noted, the same or similar steps of the following methods may be adapted to other browsers, including Microsoft's Internet Explorer.

Referring now to FIG. 6, a method 600 shown illustrating the operation of the browser control program 250 when initiated for a browser session. The method 600 is entered at step 602 and proceeds to step 604 where the browser control program 250 is initialized. At steps 606, the method 600 queries whether the version of the browser program 240 provides the necessary support. For example, some embodiments are implemented using JavaScript. Accordingly, in such embodiments, the browser program 240 must support JavaScript. If the browser program 240 does not provide the necessary support, the user is notified of this fact with a message and the method 600 exits at step 608.

If step 606 is answered affirmatively (i.e., the browser program 240 provides the necessary support), the method 600 proceeds to step 610 where the browser control program 250 sets up and enables the event handlers 252 for the controlling window. Processing and proceeds to step 612 where the geometry and chrome for the controlled window of the browser program 240 is set up.

At step 614, the method 600 queries whether the browser control program 250 is configured to implement a custom button bar (such as the button bar 402 shown in FIG. 4). If so, the geometry for the controlling window of the browser control program 250 is set up at step 616. At step 618, the custom button bar is set up within the controlling window. If, however, step 614 is answered negatively, processing proceeds to step 620 where the controlling window is set up as a hidden window. In another embodiment, the controlling window is set up as a minimized window, having an iconic representation on a task bar, for example. The particular manner in which the controlling window is implemented at step 620 is generally dependent upon the operating system 258 and/or a windows manager (if one exists for the computing environment of the client computer 222). In any case, processing and proceeds to step 622.

At step 622, the controlled window is opened according to be preconfigured geometry and chrome settings. In addition, the browser program 240 renders the content located at the selected “home” uniform resource locator (URL). At step 624, the appropriate event handlers 243 are set up and enabled to monitor events within the controlled window. In one embodiment, all event handlers 243 for the controlled window are set up, while only “required” event handlers are enabled at step 624. “Required” event handlers may include handlers configured for events including unload, abort, error, the mouse activity and keyboard activity. However, is understood that which event handlers are set up and enabled may be determined according to the particular application.

At step 626, the method 600 queries whether the browser control program 250 is configured to check for user activity. For example, it may be desirable to determine whether interaction between a user and the client computer 222 has occurred within a predetermined time period. This can be done by monitoring for the activity and registering instances of the activity. If no interaction has occurred with in the predetermined time period, the browser control program 250 may cause the browser program 240 take some action, such as proceeding to a “home page”, for example. Accordingly, if step 626 is answered affirmatively, a timer is set and started at step 628. The timer indicates a frequency with which a flag (or some variable state which indicated the user activity) is checked. The frequency with which user activity is checked may be varied according to application. Processing then proceeds to step 630. Processing also proceeds to step 630 from step 626 if step 626 is answered negatively.

At step 630, the method 600 queries whether a one second timer 260 is needed. If so, the one second timer 260 is started at step 634. In general, the one second timer 260 is used to monitor the closing of the controlled window in order to close the controlling window. In addition, the one second timer 260 is used to re-establish event handlers 252. If, at step 630, a one second timer is not needed or, if a one second timer is set at step 634, processing then proceeds to step 636 where the method 600 is ended and the event handlers are in control.

During a browsing session, the event handlers 243 and 252 serve to monitor to user input and produce a response according to the type of event handler. However, in one embodiment, the event handlers 243 are unloaded/disabled for each change in domain (i.e., each time the browser program 240 accesses a different URL). The event handlers 243 are unloaded as a result of the well-known “unload” event which occurs with a change in the URL. Accordingly, it is necessary to re-establish the event handlers 243 for the controlled window for each change in domain in order to continue monitoring user events. One embodiment for receiving and processing the unload event (by one of the event handlers 243) is illustrated by method 700 described with reference to FIG. 7.

The method 700 is entered at step 702 and proceeds to step 704 where the unload event is received. At step 706, a one second timeout is set after the expiration of which the appropriate routine is called to reset and enable the event handlers 243 configured to monitor events from the controlled window. In one embodiment, step 706 utilizes the well-known API setTimeout. Processing then proceeds to step 708.

At step 708, the method 700 queries whether the event is an attempt to access the directory of the client computer 222 via the controlled window. This determination may be made by recognizing that the user has input “file:” into the address field of the controlled window. If step 708 is answered affirmatively, processing proceeds to step 710 where the controlled window is redirected to another URL (e.g. the “home” URL). Processing then proceeds to step 712.

The remaining steps of the method 700 are directed to updating/modifying features of the custom button bar in response to a domain change. For example, at step 712 the method 700 queries whether the custom button bar is configured with an animated status indicator (such as the indicator for 16 shown in FIG. 4). If step 712 is answered affirmatively, the animated status indicator is loaded on the custom button bar at step 714. At step 716, the method 700 queries whether the custom button bar is configured with navigation buttons. If so, the status of the navigation buttons is updated at step 718. The method 700 was exited at step 720.

In addition to handling the unload event, the browser program 240 may be configured to handle other events occurring with respect to the controlled window. Such events may include, for example, click events, abort, error, load, mouse activity, keyboard activity, submit them, reset, etc. FIG. 8 shows a method 800 illustrating the handling of other events by the event handlers 243.

The method 800 is entered at step 802 and proceeds to step 804 to receive an event. At step 806, the method 800 queries whether the received event has been selected for monitoring. If so, a record of the event is recorded at step 808. The method 800 then proceeds to step 810 to query whether the custom button bar is configured with an animated status indicator. If so, the status indicator is loaded onto the custom button bar at step 812. Processing then proceeds to step 814.

At step 814, the method 800 queries whether the user selected (i.e., clicked on) a link that will cause a new window to open. This determination can be made, for example, by recognizing that the URL contained in the address field includes “open (“http” or “javascript:”. If the query 814 is answered affirmatively, processing proceeds to step 816 where the request to open another window is ignored and the content located at the specified URL is rendered in the already open controlled window. Processing then proceeds to step 818.

At step 818, the method 800 queries whether the event handlers 243 are to be re-established upon a mouse click. This may be desirable to prevent “hacking” into the underlying browser control program 250, for example. It should be noted that this effect may also be accomplished using the one second timer 260 (set at step 634 in FIG. 6) and, as such, the processing of step 818 presents an alternative implementation. If step 818 is answered affirmatively, processing proceeds to step 820 where a timer is set to re-establish the event handlers for the controlled window. In one embodiment, the timer may fire periodically (e.g., every 20 seconds) for some predetermined time period (e.g., a total of 120 seconds) to cause the event handlers to be repeatedly re-established after the initial click. Processing then proceeds to step 822.

Step 822 represents the handling of any other event within the scope of the present invention. The method 800 then ends at step 824.

As noted above, the browser program 240 may be the Netscape browser. However, other browsers can be used as long as they have the required support (e.g., JavaScript 1.3). In general, enabling and disabling of the event handlers may be accomplished according to the browser (JavaScript) documentation. In particular, a Digital Object Certificate must be attained for Netscape browsers. Another browser that may be used to advantage is Microsoft's Internet Explorer® (IE). When using IE, the onstop event handler would be used instead of unLoad event handler. Further, IE requires that a HTML Application be created instead of a HTML program in order to obtain configuration authority. For example, instead of a program named myprogram.html it must be named myprogram.hta with some additional HTML tags. One advantage with IE is that the HTML button areas are simplified and more event handlers are available to create unique solutions.

While the foregoing is directed to embodiments of the present invention, other and further embodiments of the invention may be devised without departing from the basic scope thereof, and the scope thereof is determined by the claims that follow.

What is claimed is:

1. A method for controlling a viewable browser window, comprising:
opening a controlling browser window configured to control aspects of a controlled browser window; and
opening the controlled browser window comprising a display area for rendering viewable content received from network locations.

2. The method of claim 1, wherein the viewable content is Web content.

3. The method of claim 1, wherein the aspects of the controlled browser window to be controlled by the controlling browser window comprise operational aspects and graphical aspects of a graphical user interface.

4. The method of claim 1, wherein opening the controlling browser window comprises locking at least one of a keyboard key and a mouse key.

5. The method of claim 1, wherein opening the controlling browser window comprises opening a hidden window and wherein opening the controlled browser window comprises opening a viewable window.

6. The method of claim 1, wherein the controlling browser window is opened prior to the controlled browser window and wherein the controlled browser window is opened from within the controlling browser window.

7. The method of claim 1, wherein opening the controlling browser window comprises executing a browser control program comprising event handlers and wherein the method further comprises:
re-establishing the event handlers for each change in a network address being accessed by the controlled browser program.

8. The method of claim 1, wherein opening the controlled browser window comprises executing a controlled browser program; and further comprising:
receiving user input to which the controlled browser program is configured to produce a response in a predetermined manner; and
executing the controlling browser program to prevent the response in the predetermined manner and cause a response different from the predetermined manner.

9. The method of claim 1, wherein opening the controlling browser window comprises preventing at least a portion of chrome of the controlled browser window from being displayed on an output device.

10. The method of claim 9, wherein the chrome of the controlled browser window comprises at least one of a tool bar, a menu bar, a title bar, an address field, and a border.

11. The method of claim 9, wherein the controlling browser window comprises at least one of a tool bar, a menu bar, a title bar, an address field, and a border.

12. The method of claim 1, wherein opening the controlled browser window comprises executing a controlled browser program and wherein opening the controlling browser window comprises executing a controlling browser program.

13. The method of claim 12, further comprising, in response to receiving user input configured to produce a first action by the controlled browser program, executing the controlling browser program to override the first action and produce a second action.

14. A computer readable medium containing a controlling browser program which, when executed, performs an operation for controlling a controlled browser window comprising a display area for rendering viewable content received from network locations, the operation comprising:
opening a controlling browser window configured to control aspects of the controlled browser window.

15. The computer readable medium of claim 14, wherein the viewable content is Web content.

16. The computer readable medium of claim 14, wherein the controlled browser window is opened from within the controlling browser window.

17. The computer readable medium of claim 14, wherein the aspects of the controlled browser window to be controlled by the controlling browser window comprise operational aspects and graphical aspects of a graphical user interface.

18. The computer readable medium of claim 14, wherein the operation further comprises, in response to receiving user input to which the controlled browser window is configured to produce a response in a predetermined manner:
preventing the response in the predetermined manner; and
causing a response different from the predetermined manner.

19. The computer readable medium of claim 14, wherein opening the controlled browser window comprises executing a controlled browser program selected from one of Netscape Navigator® and Microsoft Internet Explorer®.

20. The computer readable medium of claim 14, wherein opening the controlling browser window comprises locking at least one of a keyboard key and a mouse key.

21. The computer readable medium of claim 14, wherein the controlled browser window is a viewable window and wherein the controlling browser window is a hidden window.

22. The computer readable medium of claim 14, wherein opening the controlling browser window comprises preventing at least a portion of chrome of the controlled browser window from being displayed on an output device.

23. The computer readable medium of claim 22, wherein the chrome of the controlled browser window comprises at least one of a tool bar, a menu bar, a title bar, an address field, and a border.

24. The computer readable medium of claim 22, wherein the controlling browser window comprises at least one of a tool bar, a menu bar, a title bar, an address field, and a border.

25. A computer, comprising:
a memory containing at least a browser programming;
a processor which when executing the browser programming, is configured to:
open a controlling browser window configured to control aspects of a controlled browser window, the aspects comprising at least one of operational aspects and graphical aspects of a graphical user interface; and
open the controlled browser window comprising a display area for rendering viewable content received from network locations.

26. The computer of claim 15, wherein the browser programming comprises a Web browser.

27. The computer of claim 15, further comprising an input device for receiving user input and wherein, in response to receiving user input to which a first portion of the browser programming is configured to produce a response in a predetermined manner, the processor is further configured to:
execute a second portion of the browser programming to prevent the response in the predetermined manner and cause a response different from the predetermined manner.

28. The computer of claim 15, further comprising a keyboard and a mouse and wherein, by executing the browser programming to open the controlling browser window, the processor is configured to lock at least one of a keyboard key and a mouse key.

29. The computer of claim 15, further comprising a display device and wherein the controlled browser window is a viewable window on the display device and the controlling browser window is a hidden window not visible on the display device.

30. The computer of claim 15, further comprising a display device and wherein, by executing the browser programming, the processor is configured to prevent at least a portion of chrome of the controlled browser window from being displayed on the display device.

31. The method of claim 30, wherein the chrome of the controlled browser window comprises at least one of a tool bar, a menu bar, a title bar, an address field, and a border.

32. The computer of claim 15, further comprising a network connection configured to support communications with the network locations via a network.

33. The computer of claim 32, wherein the network is the Internet.
